(19) United States
(12) Patent Application Publication
(10) Pub. No.: US 2022/0239096 A1
(43) Pub. Date: Jul. 28, 2022

(54) LOAD DRIVING DEVICE

(71) Applicant: HITACHI ASTEMO, LTD., Hitachinaka-shi, Ibaraki (JP)

(72) Inventor: Akihiko GOTO, Hitachinaka-shi, Ibaraki (JP)

(73) Assignee: HITACHI ASTEMO, LTD., Hitachinaka-shi, Ibaraki (JP)

(21) Appl. No.: 17/435,916

(22) PCT Filed: Mar. 16, 2020
(86) PCT No.: PCT/JP2020/011500

§ 371 Date: Sep. 2, 2021

(30) Foreign Application Priority Data
Apr. 25, 2019 (JP) 2019-084407

(51) Int. Cl. H02H 11/00; H02H 3/18; H02H 7/18; H02J 7/00; B60R 16/033

(52) U.S. Cl. CPC H02H 11/003; H02H 3/18; B60R 16/033; H02J 7/0034; H02H 7/18

(57) ABSTRACT

A load driving device includes a lockout circuit unit (70) that, when a battery is connected in reverse to a drive circuit unit (10), autonomously decreases a gate-source voltage of an anti-reverse connection relay (41, 42) down to a voltage that interrupts conduction between a source electrode and a drain electrode.

### TECHNICAL FIELD

The present invention relates to a load driving device.

### BACKGROUND ART

Conventionally known load driving devices as disclosed in Patent Document 1 include two semiconductor relays that are provided in a power supply path from a battery to a load and are connected in series to have parasitic diodes connected in opposite directions. One of the two semiconductor relays, which has the parasitic diode of which a forward direction extends from the battery to the load, serves as an anti-reverse connection semiconductor relay. This semiconductor relay suppresses excessive current at the time of connecting the battery in reverse to the load driving device, so as to protect circuit elements of the load driving device.

### REFERENCE DOCUMENT LIST

### Patent Document

Patent Document 1: JP 2007-082374 A

### SUMMARY OF THE INVENTION

### Problem to be Solved by the Invention

Here, anti-reverse connection semiconductor relays, which receive a large load current, are generally made from an N-channel field effect transistor (FET) having low on-resistance value. If the N-channel FET is used as the anti-reverse connection semiconductor relay, it is necessary to connect a relay driver including a boosting power supply and a gate electrode of the anti-reverse connection semiconductor relay so as to drive the anti-reverse connection semiconductor relay.

However, when the battery is connected in reverse with opposite polarity to the load driving device, the relay driver may allow conduction between the ground and a gate electrode of the anti-reverse connection semiconductor relay depending on the relay driver's configuration. In this case, a potential difference may occur between a gate and a source of the anti-reverse connection semiconductor relay, to turn ON the anti-reverse connection semiconductor relay. This causes the risk of excessive current flowing through the load or the load driving device in an opposite direction to that at the time of load driving.

In view of the above problem, it is an object of the present invention to provide a load driving device that can reduce the risk of misoperation of an anti-reverse connection semiconductor relay when a battery is connected in reverse.

### Means for Solving the Problem

To achieve the above object, a load driving device according to an aspect of the present invention includes: a drive circuit unit that drives a load; a plurality of power supply systems that individually supply power from a plurality of batteries to the drive circuit unit; a plurality of first semiconductor relays provided in the plurality of power supply systems, the first semiconductor relays each having a source electrode connected to a positive electrode of each of the plurality of batteries, having a drain electrode connected to the drive circuit unit, having a gate electrode that receives a drive signal output from a driver, and having a parasitic diode of which a forward direction extends from the positive electrode of each of the plurality of batteries to the drive circuit unit; and a first circuit unit that, when at least one battery of the plurality of batteries is connected in reverse with opposite polarity to the drive circuit unit, decreases a gate-source voltage of the first semiconductor relay of the power supply system to which the at least one battery is connected in reverse, down to a voltage that interrupts conduction between the source electrode and the drain electrode.

A load driving device according to another aspect of the present invention includes: a drive circuit unit that drives a load; one power supply system that supplies power from one battery to the drive circuit unit; a first semiconductor relay provided in the one power supply system, the first semiconductor relay having a source electrode connected to a positive electrode of the one battery, having a drain electrode connected to the drive circuit unit, having a gate electrode that receives a drive signal output from a driver, and having a parasitic diode of which a forward direction extends from the positive electrode of the one battery to the drive circuit unit; and a first circuit unit that, when the one battery is connected in reverse with opposite polarity to the drive circuit unit, decreases a gate-source voltage of the first semiconductor relay, down to a voltage that interrupts conduction between the source electrode and the drain electrode.

### Effects of the Invention

According to the load driving device of the present invention, it is possible to reduce the risk of misoperation of the anti-reverse connection semiconductor relay at the time of connecting the battery in reverse.

### BRIEF DESCRIPTION OF THE DRAWINGS

FIG. 1 is a circuit diagram illustrating an example of a load driving device according to Embodiment 1.

FIG. 2 is a circuit diagram illustrating an example of a drive circuit unit of the load driving device and a load.

FIG. 3 is a circuit diagram illustrating an example of a circuit operation at the time of driving the load in FIG. 1.

FIG. 4 is a circuit diagram illustrating an example of a circuit operation at the time of connecting a battery in reverse in FIG. 1.

FIG. 5 is a circuit diagram illustrating an example of a load driving device according to Embodiment 2.

FIG. 6 is a circuit diagram illustrating an example of a circuit operation at the time of driving the load in FIG. 5.

FIG. 7 is a circuit diagram illustrating an example of a circuit operation at the time of connecting a battery in reverse in FIG. 5.

FIG. 8 is a circuit diagram illustrating an example of a circuit operation of a conventional load driving device at the time of connecting a battery in reverse.

### MODE FOR CARRYING OUT THE INVENTION

Referring to the accompanying drawings, embodiments of the present invention will be described in detail below.

### Embodiment 1

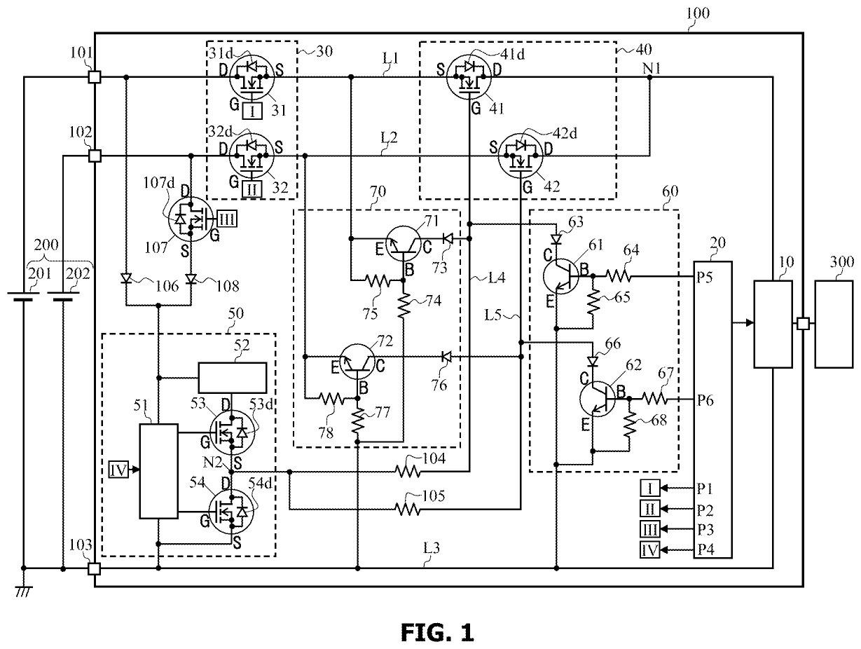

FIG. 1 illustrates an example of a load driving device according to Embodiment 1. A load driving device 100 includes a drive circuit unit 10 and a control circuit unit 20. Drive circuit unit 10 controls an amount of current to be supplied from an in-vehicle battery 200 mounted in a vehicle to a load 300 that is also mounted in the vehicle. Control circuit unit 20 controls drive circuit unit 10. A power supply system for supplying power from in-vehicle battery 200 to drive circuit unit 10 is configured for redundancy in view of improving the reliability of load driving device 100. Specifically, the power supply system is configured for redundancy by a first power supply system and a second power supply system that supply power from a first battery 201 and a second battery 202, respectively.

Control circuit unit 20 is, for example, a microcomputer and includes a central processing unit (CPU) or other processor, a random access memory (RAM) or other volatile memory, a read only memory (ROM) or other nonvolatile memory, and an input/output interface. Control circuit unit 20 receives power when an ignition switch (not illustrated) is turned ON. Control circuit unit 20 calculates a target value of current supply to load 300 based on, for example, a command signal from an upper control system (not illustrated) and output signals from various sensors (not illustrated). Then, control circuit unit 20 outputs a control signal to drive circuit unit 10 so as to bring the current supply amount from drive circuit unit 10 to load 300 closer to the target value.

Moreover, control circuit unit 20 determines whether a load current has fallen outside the target value so as to determine whether the first power supply system has an abnormality. If it is determined that the first power supply system is operating normally, control circuit unit 20 connects the first power supply system to a drive circuit while disconnecting the second power supply system from drive circuit unit 10, as described below, so that the first power supply system supplies power to drive load 300. In contrast, if an abnormality in the first power supply system is detected, control circuit unit 20 connects the second power supply system to the drive circuit while disconnecting the first power supply system from drive circuit unit 10, as described below, so that the second power supply system supplies power to drive load 300. That is, the second power supply system is used for backup when the first power supply system has an abnormality.

In load driving device 100, the first power supply system includes a first positive terminal 101 and a first positive electrode line L1. First positive terminal 101 is connected to a positive electrode of first battery 201. First positive electrode line L1 connects first positive terminal 101 and a positive electrode side of drive circuit unit 10. Moreover, in load driving device 100, the second power supply system includes a second positive terminal 102 and a second positive electrode line L2. Second positive terminal 102 is connected to a positive electrode of second battery 202. Second positive electrode line L2 connects second positive terminal 102 and first positive electrode line L1 at a connection node N1. Load driving device 100 further includes a negative terminal 103 and a negative electrode line L3. Negative terminal 103 is connected to negative electrodes of both of first and second batteries 201, 202 and is also grounded to the body, for example. Negative electrode line L3 connects negative terminal 103 and a negative electrode side of drive circuit unit 10.

Load driving device 100 includes a power supply relay unit 30 for switching connection and disconnection in relation to power supply from first and second batteries 201, 202 to drive circuit unit 10. Power supply relay unit 30 includes a first power supply relay 31 provided in first positive electrode line L1 and a second power supply relay 32 provided in second positive electrode line L2. First power supply relay 31 is a semiconductor relay that directly receives a control signal output from an output port P1 of control circuit unit 20 or indirectly receives it through a driver, for example, and is then switched ON (conducted) or OFF (not conducted) according to the received control signal. Likewise, second power supply relay 32 is a semiconductor relay that directly receives a control signal output from an output port P2 of control circuit unit 20 or indirectly receives it through a driver, for example, and is then switched ON or OFF according to the received control signal. First power supply relay 31 in an ON state allows conduction therethrough and power is supplied from first battery 201 to drive circuit unit 10. Meanwhile, first power supply relay 31 in an OFF state does not allow conduction therethrough and the power supply from first battery 201 to drive circuit unit 10 is interrupted. The same applies to second power supply relay 32.

In power supply relay unit 30, first power supply relay 31 has an anti-parallel connected diode 31d of which a forward direction extends from drive circuit unit 10 to first positive terminal 101. Likewise, second power supply relay 32 has an anti-parallel connected diode 32d of which a forward direction extends from drive circuit unit 10 to second positive terminal 102.

Load driving device 100 further includes an anti-reverse connection relay unit 40 that suppresses excessive current to protect circuit elements of load driving device 100 when first and second in-vehicle batteries 201, 202 are connected in reverse with opposite polarity. Anti-reverse connection relay unit 40 includes a first anti-reverse connection relay 41 and a second anti-reverse connection relay 42. First anti-reverse connection relay 41 is provided in first positive electrode line L1 between first power supply relay 31 and drive circuit unit 10. Second anti-reverse connection relay 42 is provided in second positive electrode line L2 between second power supply relay 32 and connection node N1. First anti-reverse connection relay 41 and second anti-reverse connection relay 42 are both semiconductor relays that are switched ON or OFF according to a drive signal received from a single anti-reverse connection relay driver 50 as described below. First anti-reverse connection relay 41 receives a drive signal through a first signal line L4. Second anti-reverse connection relay 42 receives a drive signal through a second signal line L5. First anti-reverse connection relay 41 in an ON state allows conduction therethrough, whereas first anti-reverse connection relay 41 in an OFF state does not allow conduction therethrough. The same applies to second anti-reverse connection relay 42.

First anti-reverse connection relay 41 has an anti-parallel connected diode 41d of which a forward direction extends from first positive terminal 101 to drive circuit unit 10. Likewise, second anti-reverse connection relay 42 has an anti-parallel connected diode 42d of which a forward direction extends from second positive terminal 102 to drive circuit unit 10. With the above forward direction of diode 41d, when first anti-reverse connection relay 41 is turned OFF and first battery 201 is connected in reverse, a current path between first battery 201, load 300, and drive circuit unit 10 is blocked. Likewise, with the above forward direction of diode 42d, when second anti-reverse connection relay 42 is turned OFF and second battery 202 is connected in reverse, a current path between second battery 202, load 300, and drive circuit unit 10 is blocked.

Power supply relay 31, 32 and anti-reverse connection relay 41, 42 are made from an N-channel metal oxide semiconductor field effect transistor (MOSFET) with low on-resistance value, in consideration of a load current (several A to several tens of A) flowing through load 300. First power supply relay 31 has a drain electrode (D) connected to first positive terminal 101 and has a gate electrode (G) directly or indirectly connected to output port P1 of control circuit unit 20. First anti-reverse connection relay 41 has a drain electrode (D) connected to connection node N1 and has a gate electrode (G) connected to anti-reverse connection relay driver 50 described below through first signal line L4. A resistor 104 is provided in first signal line L4. Source electrodes (S) of first power supply relay 31 and first anti-reverse connection relay 41 are connected to each other. Likewise, second power supply relay 32 has a drain electrode (D) connected to second positive terminal 102 and has a gate electrode (G) directly or indirectly connected to output port P2 of control circuit unit 20. Second anti-reverse connection relay 42 has a drain electrode (D) connected to connection node N1 and has a gate electrode (G) connected to the anti-reverse connection relay driver described below through second signal line L5. A resistor 105 is provided in second signal line L5. Source electrodes (S) of second power supply relay 32 and second anti-reverse connection relay 42 are connected to each other. First and second power supply relays 31, 32, and first and second anti-reverse connection relays 41, 42 have, as a parasitic diode, diodes 31d, 32d, 41d, and 42d, respectively.

Gate electrodes (G) of both of first and second anti-reverse connection relays 41, 42 are connected to anti-reverse connection relay driver 50 for driving first and second anti-reverse connection relays 41, 42. This is because in order to turn ON first and second anti-reverse connection relays 41, 42 as the N-channel MOSFETs, their gate electrodes (G) have to receive higher voltage than a voltage (source voltage) of source electrodes (S) to which a power supply voltage is applied. Anti-reverse connection relay driver 50 includes a logic circuit 51, a booster circuit 52, and first and second driver relays 53, 54.

When the first power supply system does not have an abnormality that hinders power supply from in-vehicle battery 200, logic circuit 51 and booster circuit 52 receive power from first positive electrode line L1 through a diode 106 having an anode connected to first positive electrode line L1. In contrast, when the first power supply system has an abnormality (for example, when a power supply voltage of first battery 201 decreases), logic circuit 51 and booster circuit 52 receive power from second positive electrode line L2 through a diode 108 and an auxiliary power supply relay 107 that is turned ON. Auxiliary power supply relay 107 is a semiconductor relay that directly receives a control signal output from an output port P3 of control circuit unit 20 or indirectly receives it through a driver, for example, and is then switched ON (conducted) or OFF (not conducted) according to the received control signal. Auxiliary power supply relay 107 in an ON state allows conduction therethrough, whereas auxiliary power supply relay 107 in an OFF state does not allow conduction therethrough. In the illustrated example, auxiliary power supply relay 107 is an N-channel MOSFET. Auxiliary power supply relay 107 has a drain electrode (D) connected to the drain electrode (D) of second power supply relay 32, has a source electrode (S) connected to an anode of diode 108, and has a gate electrode (G) connected to output port P3 of control circuit unit 20. A diode 107d as a parasitic diode of auxiliary power supply relay 107 has the forward direction extending from the source electrode (S) to the drain electrode (D).

First driver relay 53 and second driver relay 54 are connected in series between booster circuit 52 and negative electrode line L3. First driver relay 53 is switched ON or OFF according to a control signal output from logic circuit 51. First driver relay 53 in an ON state allows conduction therethrough, whereas first driver relay 53 in an OFF state does not allow conduction therethrough. The same applies to second driver relay 54. Anti-reverse connection relay driver 50 outputs a voltage of a connection node N2 that connects first driver relays 53 and second driver relay 54, as a drive signal of first and second anti-reverse connection relays 41, 42.

In the illustrated example, first and second driver relays 53, 54 are N-channel MOSFETs. A source electrode (S) of first driver relay 53 and a drain electrode (D) of second driver relay 54 are connected to each other at connection node N2. A drain electrode (D) of first driver relay 53 receives a boosted voltage output from booster circuit 52. A source electrode (S) of second driver relay 54 is connected to negative electrode line L3. Gate electrodes (G) of both of first driver relay 53 and second driver relay 54 are connected to logic circuit 51. Connection node N2 is connected to first signal line L4 and second signal line L5. A diode 53d as a parasitic diode of first driver relay 53 and a diode 54d as a parasitic diode of second driver relay 54 each have a forward direction extending from the source electrode (S) to the drain electrode (D).

Logic circuit 51 having high internal impedance is configured to receive a control signal output from an output port P4 of control circuit unit 20. Logic circuit 51 outputs, according to the control signal output from output port P4 of control circuit unit 20, a control signal for turning ON either first driver relay 53 or second driver relay 54 to first driver relay 53 and second driver relay 54. For example, logic circuit 51 outputs, according to a high-potential (H level) control signal output from output port P4 of control circuit unit 20, a control signal for turning ON first driver relay 53 and also turning OFF second driver relay 54. Meanwhile, logic circuit 51 outputs, according to a low-potential (L level) control signal output from output port P4 of control circuit unit 20, a control signal for turning OFF first driver relay 53 and also turning ON second driver relay 54. When first driver relay 53 is in an ON state, anti-reverse connection relay driver 50 outputs a drive signal at high potential equivalent to a boosted voltage output from booster circuit 52. Meanwhile, when second driver relay 54 is in an ON state, anti-reverse connection relay driver 50 outputs a drive signal at low potential equivalent to the ground potential.

Load driving device 100 includes an operation shutdown circuit unit 60 that individually stops operations of first and second anti-reverse connection relays 41, 42. Operation shutdown circuit unit 60 includes a first shutoff transistor 61 and a second shutoff transistor 62, which stop operations of first anti-reverse connection relay 41 and second anti-reverse connection relay 42, respectively. First shutoff transistor 61 connects first signal line L4 and negative electrode line L3. Second shutoff transistor 62 connects second signal line L5 and negative electrode line L3. First shutoff transistor 61 is switched ON or OFF according to a control signal output from an output port P5 of control circuit unit 20. First shutoff transistor 61 in an ON state allows conduction therethrough, whereas first shutoff transistor 61 in an OFF state does not allow conduction therethrough. Likewise, second shutoff transistor 62 is switched ON or OFF according to a control signal output from an output port P6 of control circuit unit 20. Second shutoff transistor 62 in an ON state allows conduction therethrough, whereas second shutoff transistor 62 in an OFF state does not allow conduction therethrough.

In the illustrated example, first and second shutoff transistors 61, 62 are NPN transistors. First shutoff transistor 61 has a collector electrode (C) connected to first signal line L4 through a diode 63, has an emitter electrode (E) connected to negative electrode line L3, and has a base electrode (B) connected to output port P5 of control circuit unit 20 through a base resistor 64. In addition, in first shutoff transistor 61, a base-emitter resistor 65 is connected between the base electrode (B) and the emitter electrode (E). Likewise, second shutoff transistor 62 has a collector electrode (C) connected to second signal line L5 through a diode 66, has an emitter electrode (E) connected to negative electrode line L3, and has a base electrode (B) connected to output port P6 of control circuit unit 20 through a base resistor 67. In addition, in second shutoff transistor 62, a base-emitter resistor 68 is connected between the base electrode (B) and the emitter electrode (E). When an emitter-collector voltage of first shutoff transistor 61 reaches a reverse withstand voltage thereof, diode 63 above functions to prevent backflow of a current from the emitter electrode (E) to the collector electrode (C). Moreover, when an emitter-collector voltage of second shutoff transistor 62 reaches a reverse withstand voltage thereof, diode 66 above functions to prevent backflow of a current from the emitter electrode (E) to the collector electrode (C).

Load driving device 100 includes a lockout circuit unit 70 for preventing misoperation of first and second anti-reverse connection relays 41, 42 at the time of connecting in-vehicle battery 200 in reverse. Lockout circuit unit 70 includes a first lockout transistor 71 (switch element) and a second lockout transistor 72 (switch element), which prevent misoperation of first anti-reverse connection relay 41 and second anti-reverse connection relay 42, respectively.

First lockout transistor 71 is a semiconductor element that connects first signal line L4 and first positive electrode line L1 between first power supply relay 31 and first anti-reverse connection relay 41. First lockout transistor 71 is switched ON or OFF according to a potential difference between first positive electrode line L1 and negative electrode line L3. First lockout transistor 71 in an ON state allows conduction therethrough, whereas first lockout transistor 71 in an OFF state does not allow conduction therethrough.

Second lockout transistor 72 is a semiconductor element that connects second signal line L5 and second positive electrode line L2 between second power supply relay 32 and second anti-reverse connection relay 42. Second lockout transistor 72 is switched ON or OFF according to a potential difference between second positive electrode line L2 and negative electrode line L3. Second lockout transistor 72 in an ON state allows conduction therethrough, whereas second lockout transistor 72 in an OFF state does not allow conduction therethrough.

In the illustrated example, first and second lockout transistors 71, 72 are NPN transistors. First lockout transistor 71 has a collector electrode (C) connected to first signal line L4 through a diode 73, has an emitter electrode (E) connected to first positive electrode line L1, and has a base electrode (B) connected to negative electrode line L3 through a base resistor 74. In addition, in first lockout transistor 71, a base-emitter resistor 75 is connected between the base electrode (B) and the emitter electrode (E). Likewise, second lockout transistor 72 has a collector electrode (C) connected to second signal line L5 through a diode 76, has an emitter electrode (E) connected to second positive electrode line L2, and has a base electrode (B) connected to negative electrode line L3 through a base resistor 77. In addition, in second lockout transistor 72, a base-emitter resistor 78 is connected between the base electrode (B) and the emitter electrode (E).

When an emitter-collector voltage of first lockout transistor 71 reaches a reverse withstand voltage thereof, diode 73 above functions to prevent backflow of a current from the emitter electrode (E) to the collector electrode (C). Likewise, when an emitter-collector voltage of second lockout transistor 72 reaches a reverse withstand voltage thereof, diode 76 above functions to prevent backflow of a current from the emitter electrode (E) to the collector electrode (C). Now, the case of individually checking abnormalities of first power supply relay 31 and first anti-reverse connection relay 41 is considered, for example. In this case, power supply relay 31 is turned ON and also first driver relay 53 is turned OFF to turn ON second driver relay 54 so as to turn OFF first anti-reverse connection relay 41. With this operation, it is assumed that first lockout transistor 71 has a collector voltage at the ground potential (for example, 0 V), has an emitter voltage equivalent to a power supply voltage (for example, +13 V), and has an emitter-collector voltage reaching a reverse withstand voltage thereof (for example, +5 V). However, diode 73 is provided between the collector electrode (C) of first lockout transistor 71 and first signal line L4, so that current flow from the emitter electrode (E) to the collector electrode (C) of first lockout transistor 71 is blocked.

Moreover, the following effects can be produced by connecting the emitter electrode (E) of first lockout transistor 71 to the downstream of first power supply relay 31, and connecting the emitter electrode (E) of second lockout transistor 72 to the downstream of second power supply relay 32. That is, if load 300 is not driven when first battery 201 is normally connected, first power supply relay 31 is turned OFF, so that dark current flowing through base-emitter resistor 75 and base resistor 74 can be suppressed. Likewise, if load 300 is not driven when second battery 202 is normally connected, second power supply relay 32 is turned OFF, so that dark current flowing through base-emitter resistor 78 and base resistor 77 can be suppressed.

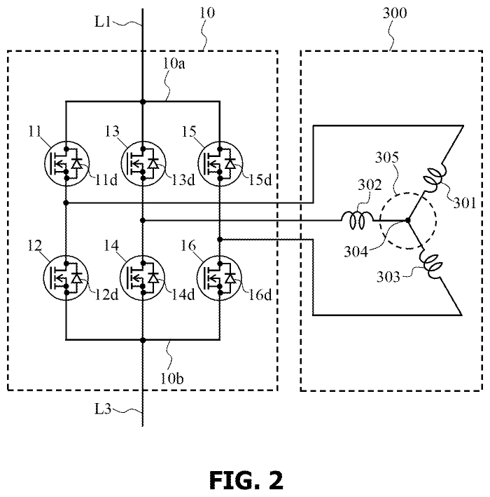

FIG. 2 illustrates an example of load 300 and drive circuit unit 10. For example, load 300 is a three-phase brushless motor with a U-phase coil 301, a V-phase coil 302, and a W-phase coil 303. Drive circuit unit 10 is an inverter for driving the three-phase brushless motor. The three-phase brushless motor as load 300 includes a cylindrical stator (not illustrated) and a rotor 305. In the stator, three-phase coils 301, 302, and 303 are wound in the form of being connected in common to a neutral point 304. Rotor 305 is a permanent magnet rotor provided rotatably at a central portion of the stator.

The inverter as drive circuit unit 10 is provided between first positive electrode line L1 and negative electrode line L3. In drive circuit unit 10, a U-phase arm, a V-phase arm, and a W-phase arm are connected in parallel between a positive electrode bus 10a connected to first positive electrode line L1 and a negative electrode bus 10b connected to negative electrode line L3. The U-phase arm is configured by series-connecting an upper switching element 11 and a lower switching element 12. The V-phase arm is configured by series-connecting an upper switching element 13 and a lower switching element 14. The W-phase arm is configured by series-connecting an upper switching element 15 and a lower switching element 16. U-phase coil 301 is connected between two switching elements 11, 12 of the U-phase arm. V-phase coil 302 is connected between two switching elements 13, 14 of the V-phase arm. W-phase coil 303 is connected between two switching elements 15, 16 of the W-phase arm.

In the inverter as drive circuit unit 10, switching elements 11 to 16 include anti-parallel connected diodes 11d to 16d, respectively, and control electrodes that can be externally controlled. Switching elements 11 to 16 perform switching operation between an ON state and an OFF state according to a control signal input to each control electrode. Switching elements 11 to 16 are arranged so that the forward directions of diodes 11d to 16d extend from negative electrode bus 10b to positive electrode bus 10a. Switching elements 11 to 16 can be, for example, MOSFETs or insulated gate bipolar transistors (IGBTs). In the illustrated example, switching elements 11 to 16 are N-channel MOSFETs, and diodes 11d to 16d thereof are parasitic diodes.

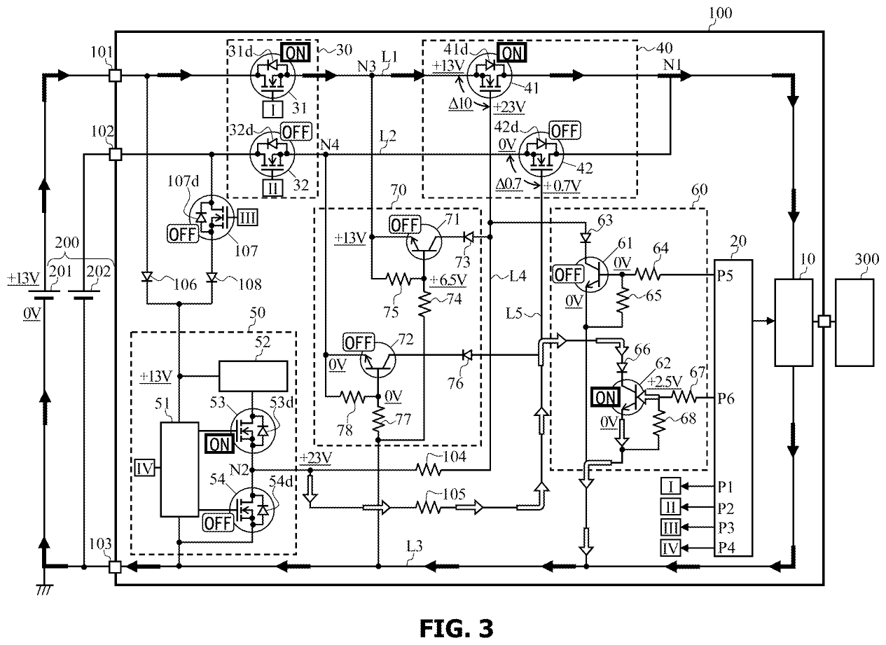

FIG. 3 illustrates an example of a circuit operation of load driving device 100 at the time of supplying power from the first power supply system to drive the load. Control circuit unit 20 outputs the following control signals from output ports P1 to P6 at the time of supplying power from the first power supply system to drive the load. From output port P1, a control signal for turning ON first power supply relay 31 is output. From output port P2, a control signal for turning OFF second power supply relay 32 is output. From output port P3, a control signal for turning OFF auxiliary power supply relay 107 is output. From output port P4, a control signal for turning ON first driver relay 53 and also turning OFF second driver relay 54 is output. From output port P5, a control signal (for example, 0 V) for turning OFF first shutoff transistor 61 is output in order to maintain first anti-reverse connection relay 41 in an ON state. From output port P6, a control signal (for example, +5 V) for turning ON second shutoff transistor 62 is output in order to turn OFF second anti-reverse connection relay 42.

Booster circuit 52 of anti-reverse connection relay driver 50 receives power supplied from first positive electrode line L1 and outputs a boosted voltage (for example, +23 V) obtained by boosting a power supply voltage (for example, +13 V) of first battery 201. In anti-reverse connection relay driver 50, first driver relay 53 is in an ON state and second driver relay 54 is in an OFF state. Therefore, a drive signal output from anti-reverse connection relay driver 50 is equivalent to the boosted voltage (for example, +23 V) generated by booster circuit 52.

At the time of driving the load with the first power supply system, first power supply relay 31 is turned ON according to the above control signal. Thus, a voltage of connection node N3 in first positive electrode line L1, which is connected to the emitter electrode of first lockout transistor 71 and the source electrode of first anti-reverse connection relay 41, is equivalent to the power supply voltage (for example, +13 V) of first battery 201. In lockout circuit unit 70, an emitter voltage of first lockout transistor 71 is equivalent to the power supply voltage (for example, +13 V) while a base voltage thereof is equivalent to a divided voltage (for example, +6.5 V) between base resistor 74 and base-emitter resistor 75, so that first lockout transistor 71 is turned OFF. Moreover, in operation shutdown circuit unit 60, a base voltage and an emitter voltage of first shutoff transistor 61 are both equivalent to the ground potential (for example, 0 V), so that first shutoff transistor 61 is turned OFF. Therefore, the drive signal, which is the boosted voltage (for example, +23 V) output from anti-reverse connection relay driver 50, is applied to the gate electrode of first anti-reverse connection relay 41 with little voltage drop. As a result, the gate-source voltage of first anti-reverse connection relay 41, which is a potential difference between the boosted voltage (for example, +23 V) and the power supply voltage (for example, +13 V), reaches or exceeds the gate threshold voltage (for example, +10 V), so that first anti-reverse connection relay 41 is turned ON. Since first power supply relay 31 and first anti-reverse connection relay 41 are both turned ON, a current can be supplied from the positive electrode of first battery 201 up to the negative electrode of first battery 201 via first positive electrode line L1, drive circuit unit 10, and negative electrode line L3 (see the thick solid line arrow of FIG. 3). Thus, control circuit unit 20 outputs a control signal to drive circuit unit 10 so as to control an amount of current to be supplied from drive circuit unit 10 to load 300, with which load 300 is driven.

Moreover, at the time of driving the load with the first power supply system, second power supply relay 32 is turned OFF according to the above control signal. Therefore, a voltage of connection node N4 in second positive electrode line L2, which is connected to the emitter electrode of second lockout transistor 72 and the source electrode of second anti-reverse connection relay 42, is equivalent to the ground potential (for example, 0 V). In lockout circuit unit 70, since the emitter voltage of second lockout transistor 72 is equivalent to the ground potential (for example, 0 V) and the base voltage thereof is also equivalent to the ground potential (for example, 0 V), second lockout transistor 72 is turned OFF. However, in second shutoff transistor 62 of operation shutdown circuit unit 60, the emitter voltage is equivalent to the ground potential (for example, 0 V) while the base voltage is equivalent to a divided voltage (for example, +2.5 V) between base resistor 67 and base-emitter resistor 68. Thus, a base-emitter voltage of second shutoff transistor 62, which is a potential difference between the base voltage (for example, +2.5 V) and the emitter voltage (for example, 0 V), reaches or exceeds a connection-portion saturation voltage (for example, +0.7 V), so that second shutoff transistor 62 is turned on. Therefore, a current flows from anti-reverse connection relay driver 50 to negative electrode line L3 via second signal line L5 and a collector and an emitter of second shutoff transistor 62 (see the hollow arrow of FIG. 3). As a result, the drive signal being the boosted voltage (for example, +23 V) output from the anti-reverse connection relay driver 50 drops down to a forward voltage (for example, +0.7 V) of diode 66 by the current flowing through resistor 105, and then is applied to the gate electrode of second anti-reverse connection relay 42. In second anti-reverse connection relay 42, a gate-source voltage (for example, +0.7 V) is lower than a gate threshold voltage (for example, +3 V), to turn OFF second anti-reverse connection relay 42. Since second power supply relay 32 and second anti-reverse connection relay 42 are both turned OFF, current supply between the positive electrode of second battery 202 and drive circuit unit 10 is interrupted.

At the time of supplying power from the first power supply system to drive load 300, control circuit unit 20 outputs the control signal as above, to electrically connect the first power supply system to drive circuit unit 10 as well as electrically disconnect the second power supply system from drive circuit unit 10.

Note that control circuit unit 20 outputs the following control signals from output ports P1 to P6 at the time of supplying power from the second power supply system to drive load 300. That is, from output port P1, a control signal for turning OFF first power supply relay 31 is output. From output port P2, a control signal for turning ON second power supply relay 32 is output. From output port P3, a control signal for turning ON auxiliary power supply relay 107 is output. From output port P4, a control signal for turning ON first driver relay 53 and also turning OFF second driver relay 54 is output. From output port P5, a control signal (for example, +5 V) for turning ON first shutoff transistor 61 is output in order to turn OFF first anti-reverse connection relay 41. From output port P6, a control signal (for example, 0 V) for turning OFF second shutoff transistor 62 is output in order to turn ON second anti-reverse connection relay 42. Also, in this way, substantially the same circuit operation as above is performed to electrically connect the second power supply system to drive circuit unit 10 as well as disconnect the first power supply system from drive circuit unit 10.

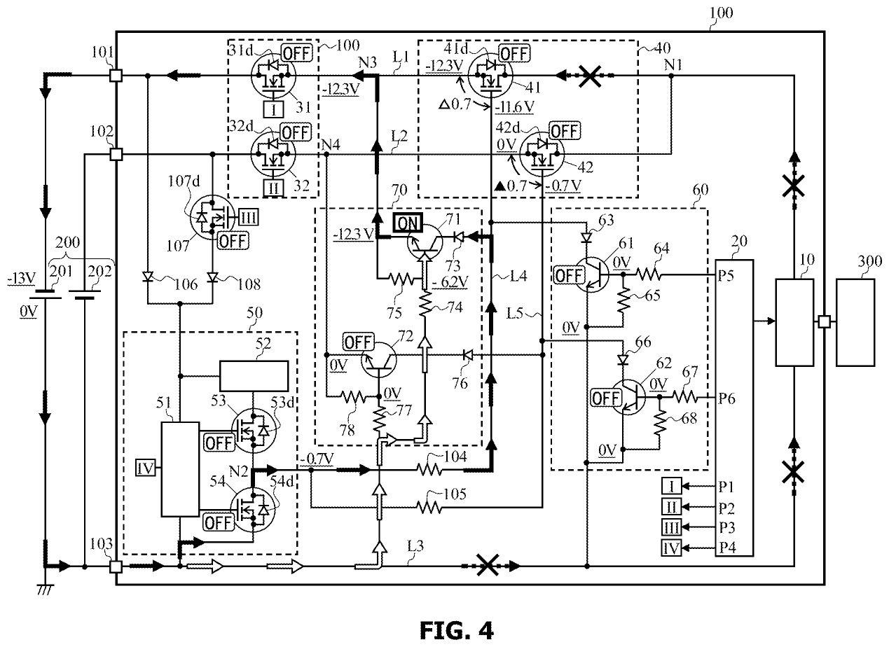

FIG. 4 illustrates a circuit operation of load driving device 100 at the time of connecting first battery 201 in reverse to load driving device 100. When first battery 201 is connected in reverse to load driving device 100, a terminal voltage of negative terminal 103 is equivalent to the ground potential (for example, 0 V), whereas a terminal voltage of first positive terminal 101 is equivalent to a voltage (for example, −13 V) obtained by subtracting the power supply voltage (for example, +13 V) from the ground potential. In general, the first battery 201 is incorrectly connected in reverse to load driving device 100 when first battery 201 is replaced with an ignition switch (not illustrated) being turned OFF. At this time, no power is supplied to control circuit unit 20, and thus no control signal is output from output ports P1 to P6 of control circuit unit 20. As a result, all of first and second power supply relays 31, 32, auxiliary power supply relay 107, first and second driver relays 53, 54, and first and second shutoff transistors 61, 62 are turned OFF. Moreover, if drive circuit unit 10 is an inverter for driving a brushless motor as load 300 as illustrated in FIG. 2, all of switching elements 11 to 16 are turned OFF as well.

However, at the time of connecting first battery 201 in reverse to load driving device 100, a first closed circuit is formed, in which a current flows from first battery 201 even if no control signal is output from output ports P1 to P6 of control circuit unit 20. In the first closed circuit, a current from the positive electrode of first battery 201 connected in reverse returns to the negative electrode of first battery 201 via base resistor 74, base-emitter resistor 75, and diode 31d of first power supply relay 31. Since resistance values of base resistor 74 and base-emitter resistor 75 are high enough, a small amount of current flows through the first closed circuit.

When a current flows through the first closed circuit, a voltage of connection node N3 drops at base resistor 74 and base-emitter resistor 75 and thus decreases from the ground potential (for example, 0 V). More specifically, the voltage of connection node N3 is equivalent to a voltage (for example, −12.3 V) higher than the terminal voltage (for example, −13 V) of first positive terminal 101 because of the forward voltage (for example, +0.7 V) of diode 31d in first power supply relay 31. The emitter voltage of first lockout transistor 71 in lockout circuit unit 70 is equivalent to a voltage (for example, −12.3 V) of connection node N3. Meanwhile, the base voltage of first lockout transistor 71 is equivalent to a voltage (for example, −6.2 V) obtained by dividing a potential difference between the ground potential and the voltage of connection node N3 by base resistor 74 and base-emitter resistor 75. Therefore, the base-emitter voltage (for example, +6.1 V) of first lockout transistor 71 reaches or exceeds the connection-portion saturation voltage (for example, +0.7 V), so that first lockout transistor 71 is turned ON and a base current flows through first lockout transistor 71 (see the hollow arrow of FIG. 4). As a result, a second closed circuit is formed, in which a current from the positive electrode of first battery 201 connected in reverse flows in load driving device 100 from negative terminal 103 to first positive terminal 101 and returns to the negative electrode of first battery 201 (see the thick solid line arrow of FIG. 4). In the second closed circuit, the current flows in load driving device 100 in the order of diode 54d of second driver relay 54, resistor 104, diode 73, the collector and the emitter of first lockout transistor 71, and diode 31d of first power supply relay 31. Note that a resistance value of resistor 104 is high enough, and thus, a small amount of current flows through the second closed circuit.

When the current flows in the second closed circuit, the gate voltage of first anti-reverse connection relay 41 drops at resistor 104 and thus decreases from the ground potential (for example, 0 V). More specifically, the gate voltage of first anti-reverse connection relay 41 is equivalent to a voltage (−11.6 V) higher than the voltage (for example, −12.3 V) of connection node N3 because of the forward voltage (for example, +0.7 V) of diode 73. In first anti-reverse connection relay 41, a gate-source voltage (for example, +0.7 V) that is a potential difference between the gate voltage (for example, −11.6 V) and the source voltage (for example, −12.3 V) is lower than the gate threshold voltage (for example, 3 V), so that first anti-reverse connection relay 41 is turned OFF. As a result, the current path is blocked, which has been formed in an opposite direction to that at the time of load driving, that is, in a direction from the positive electrode of first battery 201 connected in reverse back to the negative electrode of first battery 201 via drive circuit unit 10 (see the thick broken line arrow of FIG. 4).

When first battery 201 is connected in reverse to load driving device 100, second anti-reverse connection relay 42 is also turned OFF as follows. In second power supply relay 32 in an OFF state, the drain voltage is equivalent to the power supply voltage (for example, +13 V) of second battery 202, and the source voltage is equivalent to the ground potential (for example, 0 V), so that a current flowing from the source electrode to the drain electrode via diode 32d is interrupted. As a result, a current flowing through base resistor 77 and base-emitter resistor 78 of lockout circuit unit 70 is interrupted as well, so that the voltage of connection node N4 is equivalent to the ground potential (for example, 0 V). Moreover, in second lockout transistor 72 of lockout circuit unit 70, the base voltage and the emitter voltage are both equivalent to the ground potential (for example, 0 V), so that second lockout transistor 72 is turned OFF. As a result, the gate voltage of second anti-reverse connection relay 42 is equivalent to a voltage (for example, −0.7 V) lower than the ground potential (for example, 0 V) because of the forward voltage (for example, +0.7 V) of diode 54d of second driver relay 54. However, in second anti-reverse connection relay 42, the source voltage is equal to the voltage of connection node N4 at the ground potential (for example, 0 V) compared with the gate voltage (for example, −0.7 V), that is, the source voltage is higher than the gate voltage, so that second anti-reverse connection relay 42 is turned OFF.

In first shutoff transistor 61, the collector voltage is equivalent to the gate voltage (for example, −11.6 V) of first anti-reverse connection relay 41 and the emitter voltage is equivalent to the ground potential (for example, 0 V). At this time, the emitter-collector voltage (for example, 11.6 V) of first shutoff transistor 61 exceeds the reverse withstand voltage thereof (for example, 5 V). However, since diode 63 is connected in series to the collector electrode of first shutoff transistor 61, a current from the emitter electrode to the collector electrode of first shutoff transistor 61 is blocked.

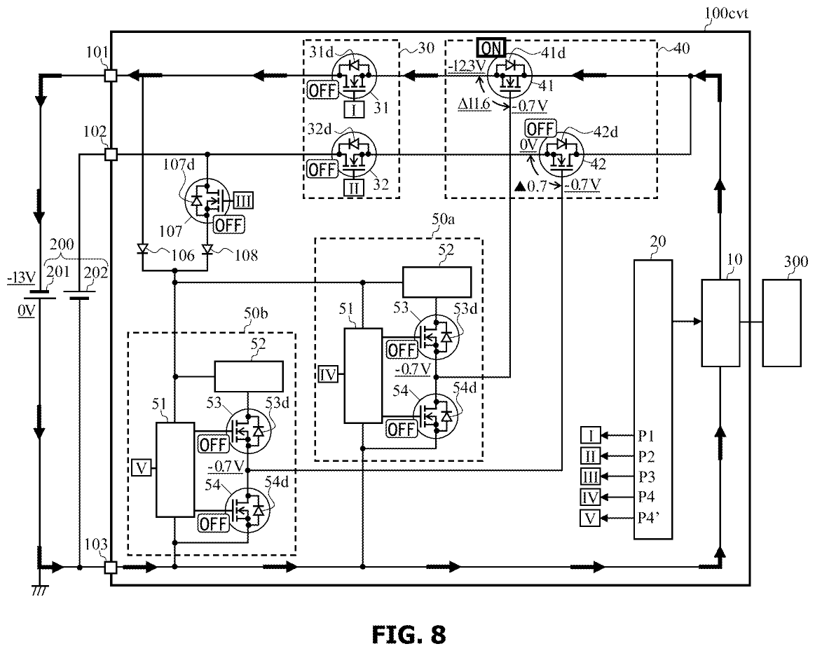

Note that the circuit operation of load driving device 100 at the time of connecting second battery 202 in reverse is substantially the same as the circuit operation of load driving device 100 at the time of connecting first battery 201 in reverse, and thus, description thereof is omitted. Referring next to FIG. 8 illustrating a conventional load driving device 100cvt, effects of load driving device 100 are described below.

FIG. 8 illustrates a circuit operation of conventional load driving device 100cvt at the time of connecting first battery 201 in reverse to conventional load driving device 100cvt. Conventional load driving device 100cvt differs from load driving device 100 in that anti-reverse connection relay drivers 50a, 50b are provided for first and second anti-reverse connection relays 41, 42 in one-to-one correspondence and operation shutdown circuit unit 60 and lockout circuit unit 70 are not provided. Note that the same components as load driving device 100 are denoted by the same reference symbols and thus are described briefly or are not described.

Anti-reverse connection relay driver 50a for first anti-reverse connection relay 41 receives a control signal output from output port P4 of control circuit unit 20 so as to control first and second driver relays 53, 54. Likewise, anti-reverse connection relay driver 50b for second anti-reverse connection relay 42 receives a control signal output from an output port P4′ of control circuit unit 20 so as to control first and second driver relays 53, 54.

When first battery 201 is connected in reverse to load driving device 100cvt, no control signal is output from output ports P1 to P4′, so that all of first and second power supply relays 31, 32, auxiliary power supply relay 107, and first and second driver relays 53, 54 are turned OFF. The gate voltage of first anti-reverse connection relay 41 is equivalent to a voltage (for example, −0.7 V) lower than the ground potential (for example, 0 V) because of the forward voltage (for example, +0.7 V) of diode 54d of second driver relay 54. The source voltage of first anti-reverse connection relay 41 is equivalent to a voltage (for example, −12.3 V) higher than the voltage (for example, −13 V) of the negative electrode of first battery 201 connected in reverse because of the forward voltage of diode 31d of first power supply relay 31. As a result, in first anti-reverse connection relay 41, the gate-source voltage (for example, +11.6 V) reaches or exceeds the gate threshold voltage (for example, +3 V), so that first anti-reverse connection relay 41 is turned ON.

When first anti-reverse connection relay 41 is turned ON, a current from the positive electrode of first battery 201 connected in reverse flows in reverse in the order of drive circuit unit 10, the drain and the source of first anti-reverse connection relay 41, and diode 31d of first power supply relay 31 and then returns to the negative electrode (see the thick solid line arrow of FIG. 8). For example, as illustrated in FIG. 2, if drive circuit unit 10 is an inverter for driving the brushless motor as load 300, in drive circuit unit 10, a current flows in reverse from negative electrode line L3 to first positive electrode line L1 via diodes 11d to 16d. Such backflow current does not flow through a resistor having a sufficiently large resistance value, and thus turns into excessive current. This means the risk of reducing the durability of load 300 or the circuit element of load driving device 100cvt, or causing element breakdown.

However, load driving device 100 includes lockout circuit unit 70 as described above, so that when first battery 201 is connected in reverse to load driving device 100, first anti-reverse connection relay 41 can be autonomously turned OFF. Therefore, the current path extending in an opposite direction to that at the time of load driving, that is, in a direction from the positive electrode of first battery 201 connected in reverse back to the negative electrode via drive circuit unit 10, is blocked. It is accordingly possible to suppress reduction in durability of load 300 or the circuit element of load driving device 100 caused by the excessive current.

Moreover, load driving device 100 includes operation shutdown circuit unit 60 as described above, so that operations of first and second anti-reverse connection relays 41, 42 can be individually stopped. Therefore, the two anti-reverse connection relays for first and second anti-reverse connection relays 41, 42 can be replaced with one anti-reverse connection relay driver 50, by which enlargement and cost increase of load driving device 100 can be suppressed.

### Embodiment 2

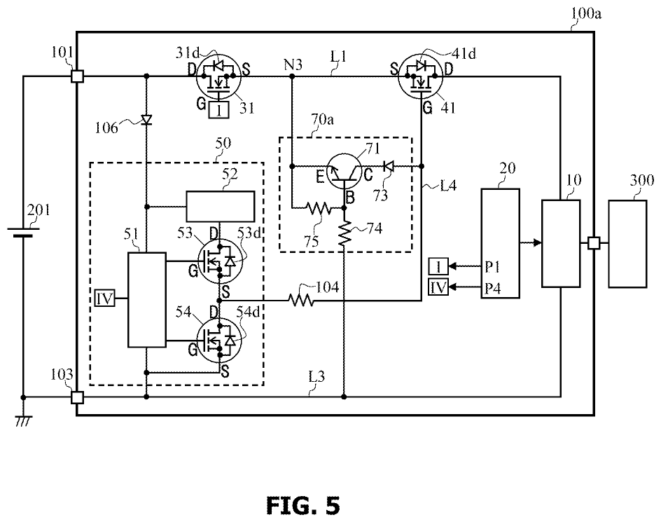

FIG. 5 illustrates an example of a load driving device according to Embodiment 2. Note that the same components as Embodiment 1 are denoted by the same reference symbols and thus are described briefly or are not described.

A load driving device 100a differs from load driving device 100 in that a power supply system for supplying power from battery 200 to drive circuit unit 10 is not configured for redundancy. Specifically, load driving device 100a includes only the first power supply system for supplying power from first battery 201, and it does not include the second power supply system of load driving device 100, which supplies power from second battery 202. Therefore, load driving device 100a dispenses with second positive electrode line L2, second signal line L5, second positive terminal 102, second power supply relay 32, second anti-reverse connection relay 42, resistor 105, auxiliary power supply relay 107, and diode 108 of load driving device 100. Moreover, load driving device 100a does not include second anti-reverse connection relay 42 and thus dispenses with operation shutdown circuit unit 60 for individually stopping the operations of first and second anti-reverse connection relays 41, 42 of load driving device 100. Furthermore, a lockout circuit unit 70a of load driving device 100a dispenses with the circuit element of load driving device 100, which prevents misoperation of second anti-reverse connection relay 42. Specifically, second lockout transistor 72 and corresponding circuit elements, that is, diode 76, base resistor 77, and base-emitter resistor 78 of load driving device 100 are omitted.

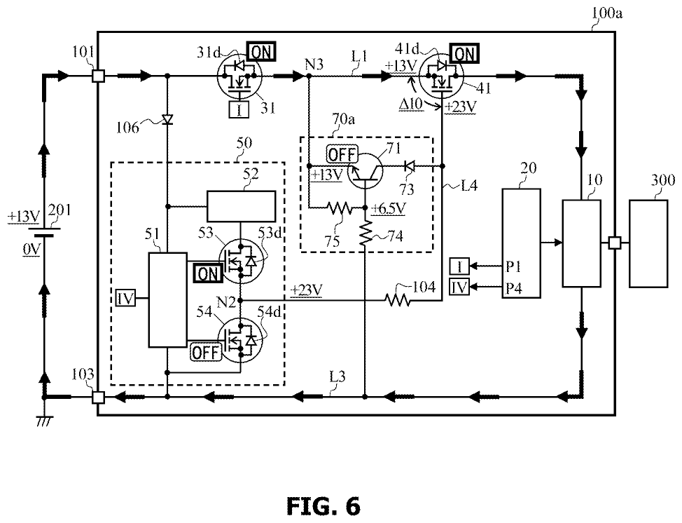

FIG. 6 illustrates an example of a circuit operation of load driving device 100a at the time of driving load 300. Control circuit unit 20 outputs the following control signals from output port P1, P4 at the time of driving load 300. From output port P1, a control signal for turning ON first power supply relay 31 is output. From output port P4, a control signal for turning ON first driver relay 53 and also turning OFF second driver relay 54 is output. In this state, substantially the same circuit operation as in load driving device 100 of FIG. 3 is performed to turn OFF first lockout transistor 71 of lockout circuit unit 70a, so that first anti-reverse connection relay 41 is turned ON. Since both of first power supply relay 31 and first anti-reverse connection relay 41 are turned ON, a current can be supplied from the positive electrode of first battery 201 up to the negative electrode of first battery 201 via first positive electrode line L1, drive circuit unit 10, and negative electrode line L3 (see the thick solid line arrow of FIG. 6). As a result, when control circuit unit 20 outputs a control signal to drive circuit unit 10, an amount of current to be supplied from drive circuit unit 10 to load 300 is controlled to drive load 300.

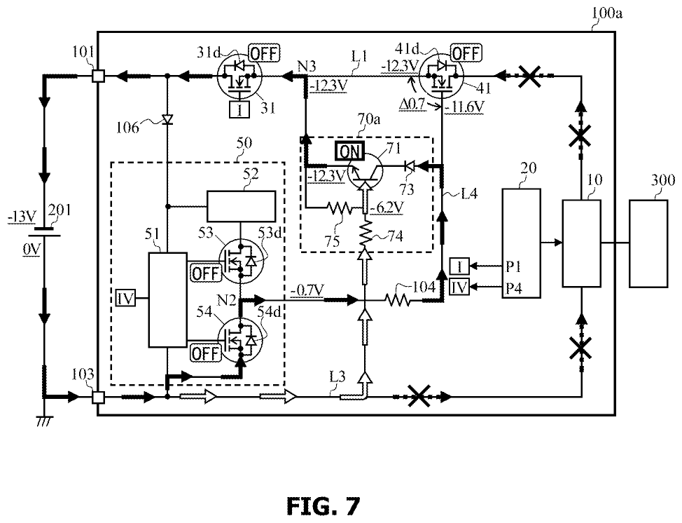

FIG. 7 illustrates a circuit operation of load driving device 100a at the time of connecting first battery 201 in reverse to load driving device 100a. In the case of connecting first battery 201 in reverse to load driving device 100a, no power is supplied to control circuit unit 20 as described above, so that no control signal is output from output port P1, P4 of control circuit unit 20. Therefore, all of first power supply relay 31, and first and second driver relays 53, 54 are turned OFF. Moreover, if drive circuit unit 10 is an inverter for driving the brushless motor as load 300 as illustrated in FIG. 2, all of switching elements 11 to 16 are turned OFF as well. Even in this state, substantially the same circuit operation as load driving device 100 of FIG. 4 is performed, to form the above-described first closed circuit, so that the base-emitter voltage of first lockout transistor 71 reaches or exceeds the connection-portion saturation voltage and then first lockout transistor 71 is turned ON. As a result, the base current flows through first lockout transistor 71 (see the hollow arrow of FIG. 7). Then, substantially the same circuit operation as load driving device 100 of FIG. 4 is performed, to form the above-described second closed circuit (see the thick solid line arrow of FIG. 7), so that the gate-source voltage of first anti-reverse connection relay 41 is lower than the gate threshold voltage and then first anti-reverse connection relay 41 is turned OFF. As a result, the current path extending in an opposite direction to that at the time of load driving, that is, in a direction from the positive electrode of first battery 201 connected in reverse back to the negative electrode via drive circuit unit 10, is blocked (see the thick broken line arrow of FIG. 7).

Since even non-redundant load driving device 100a having the single power supply system as above includes lockout circuit unit 70a, when first battery 201 is connected in reverse to load driving device 100a, first anti-reverse connection relay 41 can be autonomously turned OFF. Therefore, the current path extending in an opposite direction to that at the time of load driving, that is, in a direction from the positive electrode of first battery 201 connected in reverse back to the negative electrode via drive circuit unit 10 is blocked. It is accordingly possible to suppress reduction in durability of load 300 and the circuit element of load driving device 100 caused by excessive current.

Note that load driving device 100 has the configuration that one anti-reverse connection relay driver 50 is provided for first and second anti-reverse connection relays 41, 42, and operation shutdown circuit unit 60 individually stops operations of first and second anti-reverse connection relays 41, 42. However, load driving device 100 may have such configuration that operation shutdown circuit unit 60 is omitted, and anti-reverse connection relay drivers 50a, 50b are provided for first and second anti-reverse connection relays 41, 42 in one-to-one correspondence as in conventional load driving device 100cvt.

The circuit configuration of operation shutdown circuit unit 60 and lockout circuit unit 70, 70a is merely given by way of example. For example, first and second shutoff transistors 61, 62 and first and second lockout transistors 71, 72 may be MOSFETs or other switching elements in place of the NPN transistors. In short, operation shutdown circuit unit 60 has only to individually decrease the gate voltages of first and second anti-reverse connection relays 41, 42 according to a control signal output from control circuit unit 20. That is, operation shutdown circuit unit 60 has only to individually decrease the gate-source voltage of first anti-reverse connection relay 41 and the gate-source voltage of second anti-reverse connection relay 42 so as to selectively maintain first and second anti-reverse connection relays 41, 42 in an OFF state. Moreover, lockout circuit unit 70, 70a has only to autonomously establish conduction between the gate electrode and the source electrode of first anti-reverse connection relay 41 according to a potential difference between the source voltage of first anti-reverse connection relay 41 and the ground potential at the time of connecting first battery 201 in reverse. In addition, lockout circuit unit 70 has only to autonomously establish conduction between the gate electrode and the source electrode of second anti-reverse connection relay 42 according to the potential difference between the source voltage of second anti-reverse connection relay 42 and the ground potential at the time of connecting second battery 202 in reverse.

Load driving device 100, 100a is configured assuming that at the time of connecting first and second batteries 201, 202 in reverse, the gate electrodes of both of first and second anti-reverse connection relays 41, 42 are conducted to negative electrode line L3 via anti-reverse connection relay driver 50. Therefore, anti-reverse connection relay driver 50 may have another circuit configuration as long as the gate electrodes of both of first and second anti-reverse connection relays 41, 42 can be conducted to negative electrode line L3 via anti-reverse connection relay driver 50 at the time of connecting the battery in reverse. For example, in anti-reverse connection relay driver 50, first and second driver relays 53, 54 may be P-channel MOSFETs in place of the N-channel MOSFETs.

Drive circuit unit 10 is described above as the inverter for driving load 300 as the brushless motor by way of example, but the brushless motor may be used as an actuator of an electric power steering system or an electric braking system. Moreover, drive circuit unit 10 may drive a solenoid used in an internal engine injector and an automotive transmission or other inductive load in place of the brushless motor.

Load driving device 100 is configured for redundancy by the two power supply systems: the first power supply system for supplying power from first battery 201 and the second power supply system for supplying power from second battery 202. However, load driving device 100 may be configured for redundancy by three or more power supply systems in place of the above two systems. In this case, a shutoff transistor and a lockout transistor may be provided for each of the third and subsequent power supply systems in addition to shutoff transistor 61, 62 and lockout transistor 71, 72 provided in each of the two power supply systems.

### REFERENCE SYMBOL LIST

10 Drive circuit unit
30 Power supply relay unit
31 First power supply relay
32 Second power supply relay
40 Anti-reverse connection relay unit
41 First anti-reverse connection relay
41d Diode
42 Second anti-reverse connection relay
42d Diode
50 Anti-reverse connection relay driver
60 Operation shutdown circuit unit
61 First operation shutoff transistor
62 Second operation shutoff transistor
70, 70a Lockout circuit unit
71 First lockout transistor
72 Second lockout transistor
73, 76 Diode
100, 100a Load driving device
200 Battery
201 First battery
202 Second battery
300 Load
L1 First positive electrode line
L2 Second positive electrode line
L3 Negative electrode line
L4 First signal line
L5 Second signal line

1. A load driving device comprising:
a drive circuit unit that drives a load;
a plurality of power supply systems that individually supply power from a plurality of batteries to the drive circuit unit;
a plurality of first semiconductor relays provided in the plurality of power supply systems, the first semiconductor relays each having a source electrode connected to a positive electrode of each of the plurality of batteries, having a drain electrode connected to the drive circuit unit, having a gate electrode that receives a drive signal output from a driver, and having a parasitic diode of which a forward direction extends from the positive electrode of each of the plurality of batteries to the drive circuit unit; and
a first circuit unit that, when at least one battery of the plurality of batteries is connected in reverse with opposite polarity to the drive circuit unit, decreases a gate-source voltage of the first semiconductor relay of the power supply system to which the at least one battery is connected in reverse, down to a voltage that interrupts conduction between the source electrode and the drain electrode.

2. The load driving device according to claim 1,
wherein the first circuit unit includes, in each of the plurality of power supply systems, a switch element that connects each gate electrode of the plurality of first semiconductor relays and each source electrode of the plurality of first semiconductor relays, and
wherein the switch element autonomously establishes conduction between the gate electrode of the first semiconductor relay and the source electrode of the first semiconductor relay in the power supply system to which the at least one battery is connected in reverse.

3. The load driving device according to claim 2, wherein the switch element autonomously establishes conduction between the gate electrode of the first semiconductor relay and the source electrode of the first semiconductor relay based on a potential difference between a voltage of the source electrode of the first semiconductor relay and a ground potential in the power supply system to which the at least one battery is connected in reverse.

4. The load driving device according to claim 2,
wherein the switch element is connected to the gate electrode of the first semiconductor relay via a signal line for outputting the drive signal to the gate electrode of the first semiconductor relay from the driver in each of the plurality of power supply systems, and
wherein a diode is provided between the switch element and the signal line, the diode having a forward direction extending from the signal line to the switch element.

5. The load driving device according to claim 1, further comprising a second circuit unit that, at the time of supplying power from one power supply system of the plurality of power supply systems to drive the load in a state in which the plurality of batteries are normally connected to the drive circuit unit, decreases the gate-source voltage of the first semiconductor relay of each of the other power supply systems than the power supply system to which the power is supplied, down to a voltage that interrupts conduction between the source electrode and the drain electrode.

6. The load driving device according to claim 5, wherein the plurality of first semiconductor relays in the plurality of power supply systems each receive the drive signal from the single driver.

7. The load driving device according to claim 1, further comprising a plurality of second semiconductor relays each provided in a positive electrode line that connects the source electrode of each of the plurality of first semiconductor relays and the positive electrode of each of the plurality of batteries, in each of the plurality of power supply systems,
wherein the switch element is connected to the positive electrode line between each of the plurality of first semiconductor relays and each of the plurality of second semiconductor relays and is thus connected to the source electrode of each of the plurality of first semiconductor relays.

8. A load driving device comprising:
a drive circuit unit that drives a load;
one power supply system that supplies power from one battery to the drive circuit unit;
a first semiconductor relay provided in the one power supply system, the first semiconductor relay having a source electrode connected to a positive electrode of the one battery, having a drain electrode connected to the drive circuit unit, having a gate electrode that receives a drive signal output from a driver, and having a parasitic diode of which a forward direction extends from the positive electrode of the one battery to the drive circuit unit; and
a first circuit unit that, when the one battery is connected in reverse with opposite polarity to the drive circuit unit, decreases a gate-source voltage of the first semiconductor relay down to a voltage that interrupts conduction between the source electrode and the drain electrode.

9. The load driving device according to claim 8,
wherein the first circuit unit includes a switch element that connects the gate electrode of the first semiconductor relay and the source electrode of the first semiconductor relay, and
wherein the switch element autonomously establishes conduction between the gate electrode of the first semiconductor relay and the source electrode of the first semiconductor relay when the one battery is connected in reverse.

10. The load driving device according to claim 9, wherein the switch element autonomously establishes conduction between the gate electrode of the first semiconductor relay and the source electrode of the first semiconductor relay based on a potential difference between a voltage of the source electrode of the first semiconductor relay and a ground potential when the one battery is connected in reverse.

11. The load driving device according to claim 9,
wherein the switch element is connected to the gate electrode of the first semiconductor relay via a signal line for outputting the drive signal to the gate electrode of the first semiconductor relay from the driver, and
wherein a diode is provided between the switch element and the signal line, the diode having a forward direction extending from the signal line to the switch element.

12. The load driving device according to claim 8, further comprising a second semiconductor relay provided in a positive electrode line that connects the source electrode of the first semiconductor relay and the positive electrode of the one battery,
wherein the switch element is connected to the positive electrode line between the first semiconductor relay and the second semiconductor relay and is thus connected to the source electrode of the first semiconductor relay.
